(19) United States
(12) Patent Application Publication
(10) Pub. No.: US 2025/0272765 A1
(43) Pub. Date: Aug. 28, 2025

(54) FAMILY IDENTIFICATION METHOD BASED ON SOCIAL NETWORKS AND SPATIAL-TEMPORAL ACCOMPANYING BEHAVIORS, SYSTEM AND STORAGE MEDIUM

(71) Applicant: WUHAN UNIVERSITY, Hubei (CN)

(72) Inventors: Qiang NIU, Hubei (CN); Hao ZHANG, Hubei (CN); Wenqi FU, Hubei (CN)

(73) Assignee: WUHAN UNIVERSITY, Hubei (CN)

(21) Appl. No.: 19/064,620

(22) Filed: Feb. 26, 2025

(30) Foreign Application Priority Data
Feb. 28, 2024 (CN) 202410220091.3

(51) Int. Cl. G06Q 50/00; G06F 18/232

(52) U.S. Cl. CPC G06Q 50/01; G06F 18/232

(57) ABSTRACT

The disclosure provides a family identification method and system, comprising constructing collection of basic attribute data and spatial-temporal residence behavior data corresponding to all users in a time period in a study area based on cell phone positioning big data, obtaining the residences of all users, establishing a collection of user pairs for the user pairs whose residences satisfy a distance threshold, establishing a spatial-temporal accompanying model, and screening all possible user pairs with the family relationship through the number of spatial-temporal accompanying residence days and a spatial-temporal accompanying residence frequency to form different groups of connected subgraph clusters, identifying connected subgraph clusters with the number of users that satisfy a number threshold as a family group cluster, classifying relation between generations in family according to age difference between ages of the family group cluster and the number of times that users temporarily visited the space of an educational facility.

### CROSS-REFERENCE TO RELATED APPLICATION

This application claims the priority benefit of China Application Serial Number 202410220091.3, filed on Feb. 28, 2024. The entirety of the above-mentioned patent application is hereby incorporated by reference and made a part of this specification.

### BACKGROUND

### Technical Field

The present invention belongs to the technical field of big data analytics, and specifically relates to a family identification method based on social networks and spatial-temporal accompanying behaviors and system.

### Description of Related Art

The home is the most basic constituent unit of social life, and is a key site for understanding urban activity, society and space. Previously, household data were mainly obtained through questionnaire surveys, in-depth interviews, global positioning system (GPS) tracking surveys, and resident activity log surveys on a small scale in one or a few typical neighborhoods, with a relatively limited data sample size and lack of timeliness, which could not comprehensively, holistically, and systematically reflect the interaction patterns of household activities and urban space, and the surveys were time consuming and laborious; although in recent years a small number of techniques have been developed to identify household relationships through residence Although in recent years, a few techniques have been used to identify family relationships through residence identification and cell phone signaling data such as the number of days and frequency of nighttime calls, the difficulty of obtaining the data is limited by data privacy protection and other reasons, and thus the generalizability of the identification method is relatively low and there is a certain degree of error.

As a basic group of social life, family is essentially composed of a series of social networks, such as blood, marriage and geography, and such social network relationships are often reflected in daily life and travel behavior. With the rapid construction and development of smart cities and digital cities, the spatial-temporal resident behavioral data obtained based on cell phone positioning has become more and more massive, accurate, and accessible, thus providing a reliable, effective, and widely applicable new path for the identification of family relationships.

However, in the existing family identification-related techniques, no certain method has been given to accurately apply the spatial-temporal residence behavioral big data obtained based on cell phone positioning to identify the family relationship and to finely classify the family relationship.

### SUMMARY

According to the shortcomings of the prior art, the present invention aims to provide a family identification method and system based on social network and spatial-temporal accompanying behaviors, and the big data family samples identified by the present invention, which directly unite the users' spatial-temporal residence behavioral big data, are able to analyze the characteristics of spatial-temporal behaviors based on the family as a unit in a fast and accurate manner.

In order to solve the above technical problems, the present invention adopts the following technical solution.

A family identification method based on social networks and spatial-temporal accompanying behaviors, comprising the following steps:
based on cell phone positioning big data, constructing a collection of basic attribute data and spatial-temporal residence behavior data corresponding to all users in a time period T in a study area;
based on the collection of the basic attribute data and the spatial-temporal residence behavior data, obtaining residences of all users, and building a collection of user pairs for the user pairs whose residences are located at a distance that satisfy a distance threshold;
establishing a spatial-temporal accompanying model, screening user pairs that have occurred spatial-temporal accompanying behavior during double cease day and holidays in the time period T, determining that the user pairs with a number of spatial-temporal accompanying residence days reaching a threshold of the number of spatial-temporal accompanying residence days and a spatial-temporal accompanying residence frequency reaching a threshold of the spatial-temporal accompanying residence frequency have a family relationship, and iteratively obtaining all possible user pairs with the family relationship;
constructing a social network model by clustering the all possible user pairs with the family relationships to form different groups of connected subgraph clusters, and identifying clusters with a number of users within the connected subgraph clusters that satisfy a number threshold as a family group cluster;
classifying relation between generations in family according to a value of difference between ages of an oldest user and a youngest user in the family group cluster, and a number of times that users in the family group cluster temporarily visited a space of an educational facility during a fixed period of time on a weekday.

Further, the family identification method comprises: defining spatial-temporal residence behavior data formed when a user who stays at a same location for a period of time exceeding a stay time threshold, wherein the spatial-temporal residence behavior data includes a residence location, residence start time, residence end time and residence duration, and the basic attribute data includes a user's unique identifier code, age and gender.

Further, the family identification method comprises: according to the spatial-temporal residence behavior data, taking the residence location with a longest residence duration and a highest frequency at night as a residence of the user, constructing a one-to-one user combination between one user and other users, and traversing all users to obtain all user combinations, and if a straight-line distance of residences of the user combinations is less than a distance threshold, determining the user combinations as a user pair.

Further, the method for establishing the spatial-temporal accompanying model comprises: based on the user's spatial-temporal residence behavior data, obtaining residence start time and residence end time of two users in a user pair at a same place of residence, wherein if an absolute value of difference between the two user's residence start time and an absolute value of difference between the two user's residence end time is less than a threshold of a time difference of the two users, it is regarded as one spatial-temporal accompanying behavior, the spatial-temporal accompanying residence frequency of all user pairs in the double cease day and holiday periods in one period of time is calculated, and the number of spatial-temporal accompanying residence days is obtained and counted according date attribute in the residence start time or the residence end time corresponding to the spatial-temporal accompanying behavior.

Further, the method for constructing the social network model comprises: clustering the user pairs, recursively traversing all unvisited users that have spatial-temporal accompanying connections with a particular user, building a social network model undirected graph including all users, extracting a plurality of disconnected connected subgraph clusters through the social network model undirected graph, and in each of the said connected subgraph clusters, selecting the connected subgraph cluster with a number of users of no more than 6 as a home grouping cluster.

Further, it is assumed that the value of the difference between the age of the oldest user and the age of the youngest user in the family grouping cluster is A, when A<A1, the relation between generations in family is one-generation family, and if the number of people of the same gender is greater than or equal to 2, the family group cluster will be screened out;
when A1≤A<A2, the relation between generations in family is two-generation family;
when A>A2, the relation between generations in family is a three-generation family.

Further, the number of times that all users in the family grouping cluster temporarily visited the space of the educational facility during the fixed period of time on the working day is obtained, and when the number of times for temporarily visiting the space of the educational facility reaches a space visit count threshold and the age of the youngest user in the family grouping cluster is greater than or equal to 20 years old, the relation between generations in family is elevated by one level.

A family identification system based on social networks and spatial-temporal accompanying behaviors, comprising:
a data acquisition module, configured to construct a collection of basic attribute data and spatial-temporal residence behavior data corresponding to all users in a time period T in a study area based on cell phone positioning big data;
a user pair set establishment module, configured to obtain residences of all users based on the collection of the basic attribute data and the spatial-temporal residence behavior data, and to build a collection of user pairs for the user pairs whose residences are located at a distance that satisfy a distance threshold;
a spatial-temporal accompanying model building module, configured to establish a spatial-temporal accompanying model, screen user pairs that have occurred spatial-temporal accompanying behavior during double cease day and holidays in the time period T, determine that the user pairs with a number of spatial-temporal accompanying residence days reaching a threshold of the number of spatial-temporal accompanying residence days and a spatial-temporal accompanying residence frequency reaching a threshold of the spatial-temporal accompanying residence frequency have a family relationship, and iteratively obtain all possible user pairs with the family relationship;
a social network modeling module, configured to construct a social network model by clustering the all possible user pairs with the family relationships to form different groups of connected subgraph clusters, and identify clusters with a number of users within the connected subgraph clusters that satisfy a number threshold as a family group cluster;
a relation between generations identification module, configured to classify relation between generations in family according to a value of difference between ages of an oldest user and a youngest user in the family group cluster, and a number of times that users in the family group cluster temporarily visited a space of an educational facility during a fixed period of time on a weekday.

A family identification device based on social network and spatial-temporal accompanying behaviors comprises: a processor and a memory, the memory has a computer program stored thereon, the computer program, when executed by the processor, realizes the steps of the family identification method based on social network and spatial-temporal accompanying behaviors.

A non-transitory computer storage medium stores a computer program, the computer program, when executed by a processor, realizes the steps of t the family identification method based on social network and spatial-temporal accompanying behaviors.

Compared with the prior art, the present invention has the following advantages and beneficial effects.

Based on the spatial-temporal accompanying behavior and the spatial-temporal accompanying algorithm, as well as the social network analysis, the present invention takes the basic attribute data corresponding to all the users and the data collection of spatial-temporal accompanying behavior obtained from big data based on cell phone location (location based services (LBS)), and firstly, identifies the users' residences on the basis of the data integration and pre-processing, and then establishes a collection of user pairs for the user pairs whose residence meets the distance threshold. Then, based on the user's simultaneous and co-located residence behavior in shopping malls, parks, and other places during double cease day and holidays, user pairs with spatial-temporal accompanying behaviors is selected, and screening of user pairs is carried out through the two indicators of the number of spatial-temporal accompanying residence days and the spatial-temporal accompanying residence frequency, and it is determined that the user pairs with the number of spatial-temporal accompanying residence days reaching a threshold of the number of spatial-temporal accompanying residence days and the spatial-temporal accompanying residence frequency reaching a threshold of the spatial-temporal accompanying residence frequency have a family relationship, and all possible user pairs with the family relationship are obtained iteratively. Then, the social network model based on the user pairs with spatial-temporal accompanying behaviors is constructed, the above user pairs are clustered to form different groups of connected subgraph clusters, and the clusters with the number of users in the connected subgraph clusters that satisfy the number threshold are identified as family group clusters. Subsequently, relation between generations in family is classified based on the value of the difference between the age of the oldest user and the age of the youngest user in the family group cluster, and the number of times that the users in the family group cluster temporarily visited the space of the educational facility during a fixed time period of on a weekday. The present invention provides a method for identifying a family through cell phone positioning big data, which directly unite the users' spatial-temporal residence behavioral big data. The present invention can quickly and accurately analyze the characteristics the spatial-temporal behavioral based on the family as a unit, can be widely used and promoted, and help to realize the deep fusion of big data and small data in the study of families. The present invention provides a new method to deeply analyze the coupling of family as a unit and the interaction of urban spatial-temporal activities. The present invention provides a basis for promoting the construction of family-based living circles and the spatial-temporal allocation of service facilities, promoting the improvement of residents' quality of life, constructing a family-friendly city, and promoting the sustainable development of urban society.

### BRIEF DESCRIPTION OF THE DRAWINGS

The accompanying drawings illustrated herein are used to provide a further understanding of the present invention and form part of this application. Schematic examples of embodiments of the invention and their illustrations are used to explain the invention and do not constitute an undue limitation of the invention. In the accompanying drawings:

FIG. 1 shows a flowchart of a family identification method based on social network and spatial-temporal accompanying behavior provided by the present invention.

FIG. 2 shows a diagram of the present invention forming a family grouping cluster.

FIG. 3 shows a diagram of a family identification system based on social networks and spatial-temporal accompanying behaviors provided by the present invention.

FIG. 4 shows a chart of an identification method that can obtain the basic attributes of household members (age, gender, number of household members, etc.) and further obtain the commuting attributes of household members (commuting distance, commuting time, commuting mode, etc.) by present invention.

FIG. 5 shows a diagram of a family identification method to analyze the scenario of uneven spatial distribution of urban family commuting time by the present invention.

FIG. 6 shows a diagram of an identification of household visits to city parks through big data.

### DESCRIPTION OF THE EMBODIMENTS

The technical solutions in the embodiments of the present invention will be clearly and completely described below in conjunction with the accompanying drawings in the embodiments of the present invention.

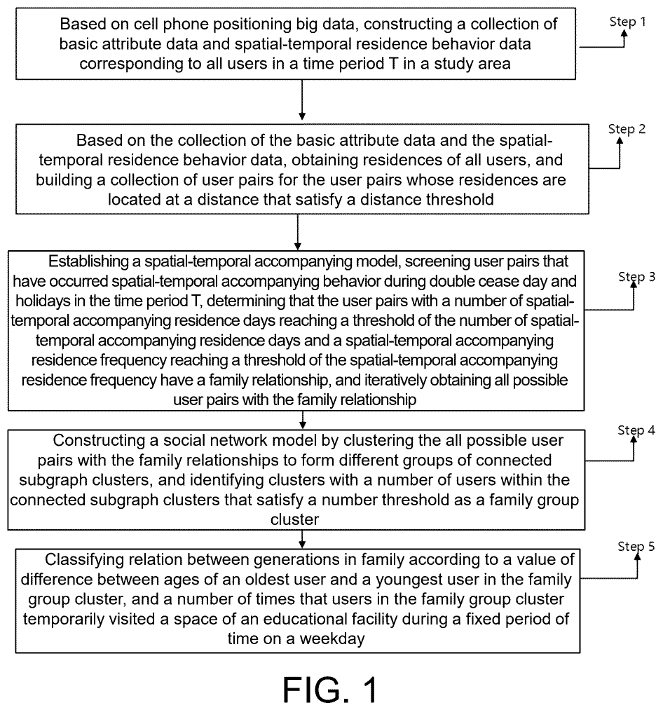

The present invention provides a family identification method based on social network and spatial-temporal accompanying behaviors, as shown in FIG. 1, comprising the following steps:
step 1: constructing a collection of basic attribute data and spatial-temporal residence behavior data corresponding to all users in a time period T in a study area based on cell phone positioning big data;
step 2: based on the collection of the basic attribute data and the spatial-temporal residence behavior data, obtaining residences of all users, and building a collection of user pairs for the user pairs whose residences are located at a distance that satisfy a distance threshold;
step 3: establishing a spatial-temporal accompanying model, screening user pairs that have occurred spatial-temporal accompanying behavior during double cease day and holidays in the time period T, determining that the user pairs with a number of spatial-temporal accompanying residence days reaching a threshold of the number of spatial-temporal accompanying residence days and a spatial-temporal accompanying residence frequency reaching a threshold of the spatial-temporal accompanying residence frequency have a family relationship, and iteratively obtaining all possible user pairs with the family relationship;
Step 4: constructing a social network model by clustering the all possible user pairs with the family relationships to form different groups of connected subgraph clusters, and identifying clusters with a number of users within the connected subgraph clusters that satisfy a number threshold as a family group cluster;
step 5: classifying relation between generations in family according to a value of difference between ages of an oldest user and a youngest user in the family group cluster, and a number of times that users in the family group cluster temporarily visited a space of an educational facility during a fixed period of time on a weekday.

Based on the spatial-temporal accompanying behavior and the spatial-temporal accompanying algorithm, as well as the social network analysis, the present invention takes the basic attribute data corresponding to all the users and the data collection of spatial-temporal accompanying behavior obtained from big data based on cell phone location (location based services (LBS)), and firstly, identifies the users' residences on the basis of the data integration and pre-processing, and then establishes a collection of user pairs for the user pairs whose residence meets the distance threshold. Then, based on the user's simultaneous and co-located residence behavior in shopping malls, parks, and other places during double cease day and holidays, user pairs with spatial-temporal accompanying behaviors is selected, and screening of user pairs is carried out through the two indicators of the number of spatial-temporal accompanying residence days and the spatial-temporal accompanying residence frequency, and it is determined that the user pairs with the number of spatial-temporal accompanying residence days reaching a threshold of the number of spatial-temporal accompanying residence days and the spatial-temporal accompanying residence frequency reaching a threshold of the spatial-temporal accompanying residence frequency have a family relationship, and all possible user pairs with the family relationship are obtained iteratively. Then, the social network model based on the user pairs with spatial-temporal accompanying behaviors is constructed, the above user pairs are clustered to form different groups of connected subgraph clusters, and the clusters with the number of users in the connected subgraph clusters that satisfy the number threshold are identified as family group clusters. Subsequently, relation between generations in family is classified based on the value of the difference between the age of the oldest user and the age of the youngest user in the family group cluster, and the number of times that the users in the family group cluster temporarily visited the space of the educational facility during a fixed time period of on a weekday. The present invention provides a method for identifying a family through cell phone positioning big data, which directly unite the users' spatial-temporal residence behavioral big data. The present invention can quickly and accurately analyze the characteristics the spatial-temporal behavioral based on the family as a unit, can be widely used and promoted, and help to realize the deep fusion of big data and small data in the study of families. The present invention provides a new method to deeply analyze the coupling of family as a unit and the interaction of urban spatial-temporal activities. The present invention provides a basis for promoting the construction of family-based living circles and the spatial-temporal allocation of service facilities, promoting the improvement of residents' quality of life, constructing a family-friendly city, and promoting the sustainable development of urban society.

In step 1 of the present invention, based on the spatial-temporal residence behavior data obtained from the cell phone positioning big data, the spatial-temporal residence behavior data, which is formed when a user who stays at a same location for a period of time exceeding a stay time threshold, is defined. The spatial-temporal residence behavior data includes a residence location, residence start time, residence end time and residence duration, and the basic attribute data includes a user's unique identifier code, age and gender.

Specifically, the user Uᵢ as an example for illustration. Herein, i is the unique identification code of the user, the user is defined Uᵢ stay in the same location for more than 30 minutes to form spatial-temporal residence behavior data, the residence location of users staying in the grid of the study area can be inferred through the weighting algorithm of multi-cellular base station. Monthly spatial-temporal residence behavior data of the user Uᵢ is extracted by month and sorted in chronological order, including all the residence number, residence location, residence start time, residence end time, and residence duration of the user Uᵢ in a certain month. The spatial-temporal residence behavior data set of each user Rᵢ={U_{i,1-1}, U_{i,1-2}, . . . , U_{i,c-d}} is constructed, U_{i,c-d} denotes the spatial-temporal residence behavior data of a certain user Uᵢ on the c-th day of the month, and then all users are traversed to form the spatial-temporal residence behavior data set of all users S={R₁, R₂, . . . , Rᵢ}, Rᵢ denotes all spatial-temporal resident behavior data of a certain user.

In step 2 of the present invention, based on the spatial-temporal residence behavior data, the residence location with the longest residence time and the highest frequency at night is regarded as the residence. Specifically, before carrying out residence identification of the user, it is necessary to determine whether the user is a core user, which includes the following steps.

Step S21, based on the number of days the user resides in the city during the time period T exceeding a threshold number of days, it states that the user is the core user, meaning a user who has been active in the city for a long period of time, and excludes the possibility of a visit; otherwise, the user is a non-core user. The present invention only identifies the families of core users that are within the study area. Specifically, in the embodiment of the present invention, the time period T is 1 month and the days threshold is 20 days.

Step S22, residence location identification: residence location of the user Uᵢ is calculated, and the residence night time period of the user is defined as the current day.

From 21:00 μm to 8:00 am the next day, the spatial-temporal residence behavior data set of all users S is taken as the object, the monthly cumulative total residence time of different users in different residence locations is summarized, and the residence locations with the largest residence duration and the highest frequency are taken as the residence location A_{U}_{ᵢ} of the user Uᵢ denoted as A_{U}_{ᵢ}={X_{U}_{ᵢ}, Y_{U}_{ᵢ}}, X_{U}_{ᵢ} and Y_{U}_{ᵢ} represents the longitude and latitude of the residence location of the the user Uᵢ, i.e., the residence location of the user in the grid of the study area generated by the multi-base station weighting algorithm.

Step S23, the residence distance threshold is determined. For the remaining user set P={P₁, P₂, . . . , Pₛ} except the user Uᵢ, Pₛ represents a user except user Uᵢ, the above steps S21 and S22 are looped to recognizing the residence location, and the straight-line distance between all other user set P and the residence of user Uᵢ, the straight-line distance

$$D = \{ {D}_{{A}_{{U}_{i}} {A}_{{P}_{1}}} , {D}_{{A}_{{U}_{i}} {A}_{{P}_{2}}} , … , {D}_{{A}_{{U}_{i}} {A}_{{P}_{s}}} \} ,$$

wherein

$${D}_{{A}_{{U}_{i}} {A}_{{P}_{s}}}$$

denotes the direct distance between the residence A_{U}_{ᵢ} and the residence location A_{P}_{ₛ}, A_{P}_{ₛ}={X_{P}_{ₛ}, Y_{P}_{ₛ}} is the residence information of user Pₛ, X_{P}_{ₛ} and Y_{P}_{ₛ} represent the longitude and latitude of the user Pₛ, respectively. The user pairs in the D dataset that are less than or equal to the distance threshold of are selected (note: here, the distance threshold of is 300 meters, which is selected based on the average coverage of cellular base stations in the central urban area), and the user set Q={Q₁, Q₂, . . . , Qₙ} that satisfying the distance threshold condition from the remaining user set P is selected, the collection of user pairs U_Q={UᵢQ₁, UᵢQ₂, . . . , UᵢQₙ} is constructed, where UᵢQₙ denotes the two users Uᵢ and Qₙ whose residence distance is less than the distance threshold, i≤n (i, n are the unique identification codes of the users to avoid double counting between user pairs).

In step S3 of the present invention, a spatial-temporal accompanying model is established, comprising: based on the user's spatial-temporal residence behavior data, obtaining residence start time and residence end time of two users in a user pair at a same place of residence, wherein if an absolute value of difference between the two user's residence start time and an absolute value of difference between the two user's residence end time is less than a threshold of a time difference of the two users, it is regarded as one spatial-temporal accompanying behavior, the spatial-temporal accompanying residence frequency of all user pairs in the double cease day and holiday periods in one period of time is calculated, and the number of spatial-temporal accompanying residence days is obtained and counted according date attribute in the residence start time or the residence end time corresponding to the spatial-temporal accompanying behavior, and determining that a user pair with a number of spatial-temporal accompanying residence days reaching a threshold of the number of spatial-temporal accompanying residence days and a spatial-temporal accompanying residence frequency reaching a threshold of the spatial-temporal accompanying residence frequency have a family relationship, traversing all user pairs and obtaining all possible user pairs with the family relationship. The step S3 includes the following steps.

Step S31: the spatial-temporal accompanying residence frequency of users going to parks, shopping malls and other places on double cease day and holidays. Comparing with non-family members, users with family relationships often have common leisure travel activities, so “spatial-temporal accompanying residence frequency indicator of users going to parks, shopping malls and other places on double cease day and holidays” is proposed. For the user pairs that satisfying the residence distance threshold in step 2, the records with the same spatial residence behavior on double cease day and holidays are extracted, residence start time is obtained and it is calculated to form the residence time difference dataset ST of the user pairs at the residence location,

$$ST = \{ {ST}_{{U}_{{i}_{stime}}} {ST}_{{Q}_{{n}_{stime}}} , {ST}_{{U}_{{i}_{etime}}} {ST}_{{Q}_{{n}_{etime}}} \} ,$$

where

$${ST}_{{U}_{{i}_{stime}}}$$

denotes the residence start time of the research object Uᵢ at a particular residence location,

$${ST}_{{U}_{{i}_{etime}}}$$

denotes the residence end time of the research object Uᵢ at a particular residence location,

$${ST}_{{Q}_{{n}_{stime}}}$$

denotes the residence start time of a user Qₙ in the same residence location in all other user set Q,

$${ST}_{{Q}_{{n}_{etime}}}$$

denotes the residence end time of the user Qₙ stay at the same residence location, if the absolute value of

$${ST}_{{U}_{{i}_{stime}}} - {ST}_{{Q}_{{n}_{stime}}}$$

and the absolute value of

$${ST}_{{U}_{{i}_{etime}}} - {ST}_{{Q}_{{n}_{etime}}}$$

are both less than the threshold of a time difference, by considering the time interval formed by the dwelling point, the threshold of a time difference is set to 30 minutes according to the actual situation, and finally the user's spatial-temporal accompanying residence frequency dataset SF_{U}_{ᵢ}_{Q}_{ₙ}^{T} is formed, that is, the number of times the user pair UᵢQₙ has significant spatial-temporal accompanying behaviors during the T period of double cease day and holidays in a certain month, and a spatial-temporal accompanying residence frequency of users Qₙ and research objects Uᵢ on multiple double cease day and holidays is obtained.

Step S32, the number of spatial-temporal accompanying residence days: since the user's prolonged residence behavior in the same location will result in multiple residence locations, there may be some bias in using only the “spatial-temporal accompanying residence frequency”, so “the number of spatial-temporal accompanying residence days” indicator is proposed, which is denoted as SD_{U}_{ᵢ}_{Q}_{ₙ}^{T}, and represents the data set of the number of spatial-temporal accompanying residence days for user pairs UᵢQₙ who have significant spatial-temporal accompanying behaviors during the holiday period T of a certain month.

Step S33, it is determined that whether the two users within the user pair have a family relationship: for the user pairs UᵢQₙ of the collection of user pairs U_Q that satisfying the residence distance threshold in step S31, a feature set L={SD_{U}_{ᵢ}_{Q}_{ₙ}^{T},SF_{U}_{ᵢ}_{Q}_{ₙ}^{T}} of the number of spatial-temporal accompanying residence days and the spatial-temporal accompanying residence frequency is constructed. Family relationship discrimination is performed based on two indexes, the number of spatial-temporal accompanying residence days SD_{U}_{ᵢ}_{Q}_{ₙ}^{T} and the spatial-temporal accompanying residence frequency SF_{U}_{ᵢ}_{Q}_{ₙ}^{T} in the feature set L. Based on the kneed algorithm, the point with the maximum curvature on the curve is selected as the inflection point. First, a fitting curve of spatial-temporal accompanying contact pairs and the number of residence days is generated, The curvature of each point is calculated, the point with the maximum curvature is selected as a threshold e of the number of spatial-temporal accompanying residence days, i.e. SD_{U}_{ᵢ}_{Q}_{ₙ}^{T}≥ e, then on the basis of satisfying the number of the spatial-temporal accompanying residence days, the fitting curve of spatial-temporal accompanying contact pairs and residence frequency is generated, and the point with the maximum curvature is also selected as a threshold value f of the spatial-temporal accompanying residence frequency, i.e. SF_{U}_{ᵢ}_{Q}_{ₙ}^{T}≥f, then it is considered that “there may be a family relationship” between the two users, otherwise it is a non-family relationship. Accordingly, the user feature set O={SF_{U}_{ᵢ}_{F}_{ᵥ}^{T},SF_{U}_{ᵢ}_{F}_{ᵥ}^{T}} that may have family relationships is extracted from the feature set L of the number of spatial-temporal accompanying residence days and the spatial-temporal accompanying residence frequency, UᵢFᵥ is the user pair that may have a family relationship after screening the collection of user pairs U_Q, i.e., user Uᵢ and user Fᵥ.

Step S34, step S31 to step S33 are executed repeatedly to identify all user pairs and obtain the data set U_F={UᵢF₁, UᵢF₂, . . . , UᵢFᵥ} of all user pairs that may have a family relationship.

In step S4 of the present invention, the method for constructing the social network model involves:
clustering all user pairs in the data set U_F of all user pairs, recursively traversing all unvisited users that have spatial-temporal accompanying connections with a particular user, building a social network model undirected graph including all users, extracting a plurality of disconnected connected subgraph clusters through the social network model undirected graph, and selecting, in each of the connected subgraph clusters, a connected subgraph cluster with a number of users not exceeding 6 as a home grouping cluster.

Specifically, step S4 comprises the following steps.

Step S41, a social network model undirected graph is constructed based on the data set U_F of all user pairs with family relationships in step 3.

The function of nx.connected_components in the library of Python 3.9.7 software is used to construct the social network model undirected graph between users.

The connected component is found by using a depth-first search (DFS) algorithm that recursively traverses all unvisited users that have a spatial-temporal accompanying connections with that user, starting with each unvisited user in the graph, and marks those nodes as visited. The connected component is found when all users adjacent to that node have been traversed. The algorithm then proceeds to find the next unvisited user in the graph and recursively traverses all unvisited users adjacent to it until all users have been visited.

Step S42, one disconnected connected subgraph cluster is extracted according to the social network model undirected graph, and a connected subgraph cluster set E={E₁, E₂, . . . , E_{g}} is constructed, where E_{g} denotes the g-th connected subgraph cluster in the connected subgraph cluster set, i.e., the other users who have family relationships with the user U after filtering by conditions.

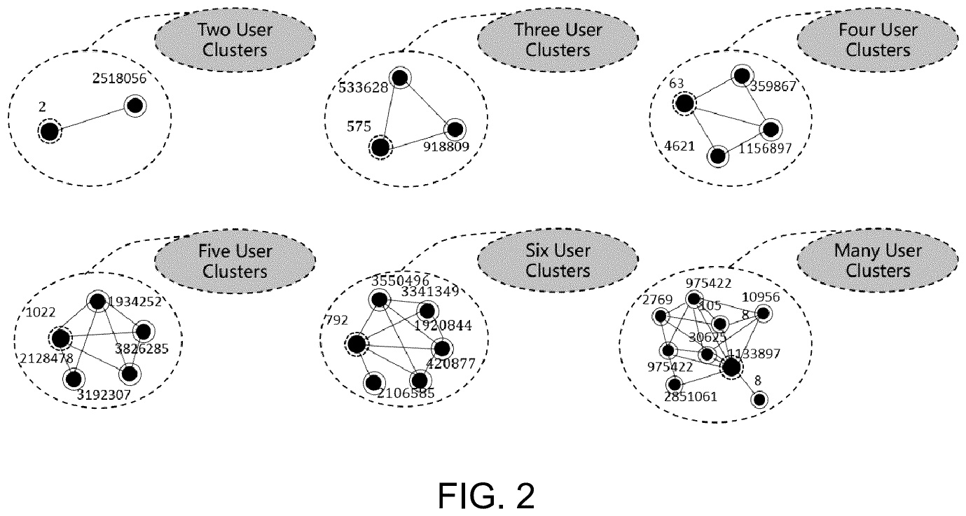

Step S43, as shown in FIG. 2, considering the relation between generations (three generations), the connected subgraph clusters with “the number of users≤6” are extracted as the family cluster clusters, which are denoted as the family group cluster set H={H₁, H₂, . . . , Hₖ}, where Hₖ denotes the k-th family group cluster in the family group cluster set.

In step S5 of the present invention, a relation between generations in family is classified according to the value of the difference between the age of the oldest user and the age of the youngest user in the family group cluster, and the number of times that the users in the family group cluster have temporarily visited the space of the educational facility during a fixed period of time on a weekday: based on the family group cluster identified in step S4, age information of the users in the family group cluster is obtained, and the numerical value of the age difference between the oldest user and the youngest user in the family group cluster is calculated to identify the relation between generations in family of the family group cluster. When A<A1, the relation between generations in family is the “one-generation family”, the cluster is labeled as “1”, but considering the situation of staff dormitory and group dormitory, the cluster of “number of people of the same gender ≥2” is screened out and labeled as “0”; when A1≤A<A2, the relation between generations in family is the “two-generation family”, the cluster is labeled as “2”; when A>A2, the relation between generations in family is the “three-generation family”, the cluster is labeling as “3”.

Specifically, assuming that the value of the difference between the age of the oldest user and the age of the youngest user in the family group cluster be A, and considering the legal age of marriage in China, A1 and A2 are 25 and 50 respectively, i.e., when A<25, the relation between generations in family is the one-generation family, if the number of people of the same gender ≥2, the family group cluster will be screening out; when 25≤A<50, the relation between generations in family is the two-generation family; when 50≤A, the relation between generations in family is the third-generation family.

In the present invention, since most of the children of families do not possess cell phones in the kindergarten and elementary school stages, the big data cannot recognize their user attribute information. Therefore, on the basis of the above preliminary identification of relation between generations in family, the identification of users in kindergarten and elementary school may be missed, resulting in inaccurate identification of intergenerational relationships. Consequently, it is necessary to improve the identification of relation between generations in family based on the number of times that users in the family group cluster temporarily visit the space of educational facilities at a fixed period of time on weekdays:
obtaining the number of times that all users in the family group cluster temporarily visit the space of educational facilities at a fixed period of time on weekdays, and when the number of times of temporarily visit the space of educational facilities reaches a space visit count threshold and the age of the youngest user in the family group cluster is greater than or equal to 20 years old, then elevating the relation between generations in family by one level.

Specifically, the number of times that users within the family group cluster temporarily stay in the space of educational facilities such as kindergartens and elementary schools during the school and after-school hours from Monday to Friday in a certain month is counted as E_S, and the relation between generations in family in step S5 is further subdivided, respectively, there are the following three scenarios.

For the one-generation family, when the number of times E_S that any user in the family temporarily visited the space of the educational facility is greater than or equal to 8, and the minimum age of the users in the family is greater than or equal to 20 years old, it indicates that there are children in the family, and thus the one-generation family is transformed into the two-generation family, the cluster is re-labeled as “2”, and the remaining clusters are still the one-generation families;

For the two-generation family, when the number of times E_S that any user in the family temporarily visited the space of the educational facility is greater than or equal to 8, and the minimum age of the users in the family is greater than or equal to 20 years old, it indicates that there are children in the family, and thus the two-generation family is transformed into the three-generation family, the cluster is re-labeled as “3”, and the remaining clusters are still two-generation families.

For the three-generation family, when the number of times E_S that any user in the family temporarily visited the space of the educational facility is greater than or equal to 8, and the minimum age of the users in the family is greater than or equal to 20 years old, it indicates that there are children in the family, and thus the three-generation family is transformed into the four-generation families, the cluster is re-labeled as “4”, and the remaining clusters are still three-generation families.

When the minimum age of any user in the household is no less than 20 years old, it indicates that there are children in the household, and thus it is transformed from a four-generation household to a five-generation household, and the cluster is re-labeled as “5”, while the rest of the clusters are still four-generation households.

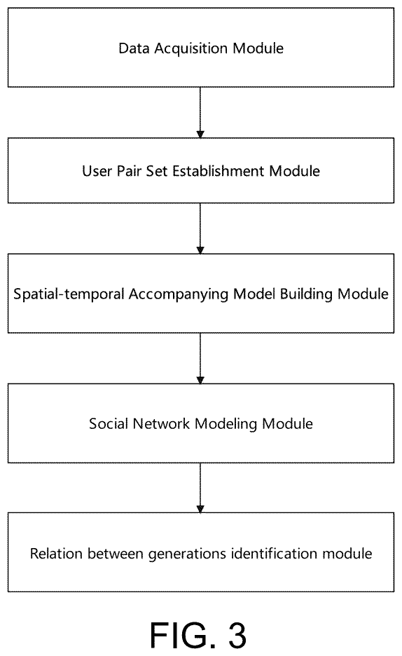

A detailed description of the specific implementation of the present invention is given below in conjunction with the accompanying FIG. 3. Taking a certain city as an example, the invention is based on the cell phone signaling data provided by Unicom's “Smart Footprint” big data platform in a certain city in 2023, and identifies 3,879,480 core users of Unicom in a certain city, and generates 25,371,462 pieces of spatial-temporal residence behavior data (non-residence and non-workplace) during the double cease day and holidays in June 2023, totaling forming 50,571,893 pairs of one-to-one user combinations. In view of the fact that a pair of user pairs may form different residence connections in different times and spaces, 8,050,031 different user pairs are constructed by aggregating the two key indicators of spatial-temporal accompanying residence frequency and the number of spatial-temporal accompanying residence days, and 4,049,846 user pairs that may have family relationships are retained through the screening of by the two indicators of the spatial-temporal accompanying residence frequency and the number of spatial-temporal accompanying residence days. Finally, 269,892 users are filtered by spatial-temporal accompanying model and social network model, and 105,778 family clusters are formed. The technical process is demonstrated as follows.

In the present invention, firstly, the basic attribute information such as the user's unique identification number (uid), age, gender, etc. in June 2023 is obtained; and then the user's spatial-temporal residence behavior data in June 2023 is obtained, including the user's place of residence (home), place of employment (work), residence number (move_id), residence start time (stime), residence end time (etime), number of residence location grid (grid_id), latitude and longitude of the center point of the residence location grid (grid_id_coordinate), and so on. The data are described in Table 1:

Table 1 shows a description table of user base attribute information and spatial-temporal residence behavior data.

| Basic Attribute Information | | | Spatial-Temporal Residence Behavior Data | | | | | | |
|---|---|---|---|---|---|---|---|---|---|
| (uid) | gende | age | home | work | move_id | stime | etime | grid_id | grid_id_coordinate |
| *****************1 | 01 | 07 | (116.07213, | (116.22101, | 1 | 2023-6-1 | 2023-6-1 | 5563 | (116.22101, |
| | (male) | (30-35 | 39.66065) | 39.90084) | | 7:17 | 7:29 | | 39.90084) |
| | | years old) | | | | | | | |
| | 01 | 07 | | | 2 | 2023-6-1 | 2023-6-1 | 4025 | (116.24098, |
| | (male) | (30-35 | | | | 9:23 | 9:26 | | 39.87185) |
| | | years old) | | | | | | | |
| | 01 | 07 | | | 3 | 2023-6-1 | 2023-6-1 | 4068 | (116.55166, |
| | (male) | (30-35 | | | | 15:51 | 16:02 | | 39.37254) |
| | | years old) | | | | | | | |
| | 01 | 07 | | | 4 | 2023-6-1 | 2017-6-1 | 4128 | (116.72361, |
| | (male) | (30-35 | | | | 17:35 | 17:36 | | 39.38592) |
| | | years old) | | | | | | | |
| | 01 | 07 | | | 5 | 2023-6-1 | 2023-6-1 | 4328 | (116.97231, |
| | (male) | (30-35 | | | | 19:44 | 21:45 | | 39.11564) |
| | | years old) | | | | | | | |
| | 01 | 07 | | | 6 | 2023-6-2 | 2023-6-2 | 4314 | (116.22101, |
| | (male) | (30-35 | | | | 3:46 | 7:19 | | 39.90072) |
| | | years old) | | | | | | | |
| | 01 | 07 | | | 7 | 2023-6-2 | 2023-6-2 | 4367 | (116.25736, |
| | (male) | (30-35 | | | | 11:55 | 12:13 | | 39.90084) |
| | | years old) | | | | | | | |
| | 01 | 07 | | | 8 | 2023-6-2 | 2023-6-2 | 5201 | (116.33541, |
| | (male) | (30-35 | | | | 17:05 | 17:26 | | 38.95362) |
| | | years old) | | | | | | | |
| | 01 | 07 | | | 9 | 2023-6-3 | 2023-6-3 | 5564 | (116.42015, |
| | (male) | (30-35 | | | | 8:50 | 8:53 | | 38.32876) |
| | | years old) | | | | | | | |

In the present invention, in step 2. based on Table 1. the basic attribute information and spatial-temporal residence behavior data of users in the study area are obtained, wherein the place of residence and the place of work are determined according to the spatial-temporal residence behavior data of the users in June 2023, the place of residence is determined to be the location with the longest stay time and the highest frequency from 21:00 of the same day to 8:00 of the next day, and the place of work is determined to be the location with the longest stay time and the highest frequency from 9:00 of the same day to 17:00 of the same day. The place of work is identified as the location with the longest stay time and highest frequency and not the location of residence. At the same time, based on geospatial data, the boundary range of a city, the spatial range of kindergartens and elementary school (the data of the study boundary range comes from the boundaries of the jurisdiction announced by the relevant government), and the spatial range of kindergartens and elementary school (from the data of the AOI of Gaode Maps in June 2023), are obtained and uploaded to the platform of “Intelligent Footprints”.

In the present invention, the data is preprocessed to form a collection of data on the user's spatial-temporal residence behavior, specifically comprising:
defining users Uᵢ staying in the same location for more than 30 minutes to form the spatial-temporal residence behavior data, taking user Uᵢ=“575” as an example, extracting the user's spatial-temporal residence behavior data in June 2023, and sorting them in chronological order, including all the residence numbers, residence locations, residence start time and residence end time of the user U₅₇₅ In June 2023, extracting the user's spatial-temporal residence behavior data, and sorting them in chronological order, including the user's residence number, residence location, residence start time, residence end time, etc., so as to construct the user's spatial-temporal residence behavior data set S={S_{575,1-1}, S_{575,1-2}) . . . , S_{575,30-20}}, S_{575,30-20} representing the user U₅₇₅ on the 30th day of June 2023, after statistics, the user “575” has a total of 650 residence data in June 2023. And through the weighting algorithm of multiple cellular base stations, it can be inferred that the user's coordinate point location in the grid of cellular base stations in the center of the city AREA_{c,d}. The above data is shown in Table 2:

Table 2 shows a descriptive table of spatial-temporal residence behavior data for user Uᵢ “575” in June 2023.

| move_id | stime | etime | grid_id | grid_id_coordinate |
|---|---|---|---|---|
| 1-1(1st stay | 2023 Jun. 1 | 2023 Jun. 1 | 5268 | (116.22101, |
| on June 1) | 0:15 | 9:56 | | 39.90084) |
| 1-2(2nd stay | 2023 Jun. 1 | 2023 Jun. 1 | 5308 | (116.24098, |
| on June 1) | 10:16 | 11:34 | | 39.87185) |
| 1-3(3rd stay | 2023 Jun. 1 | 2023 Jun. 1 | 5260 | (116.55166, |
| on June 1) | 11:42 | 15:29 | | 39.37254) |
| 1-4(4th stay | 2023 Jun. 1 | 2023 Jun. 1 | 5260 | (116.72361, |
| on June 1) | 15:32 | 23:37 | | 39.38592) |
| 2-1(1st stay | 2023 Jun. 2 | 2023 Jun. 2 | 5372 | (116.97231, |
| on June 2) | 0:54 | 10:18 | | 39.11564) |
| 2-2(2nd stay | 2023 Jun. 2 | 2023 Jun. 2 | 5416 | (116.22101, |
| on June 2) | 13:29 | 18:39 | | 39.90072) |
| 2-3(3rd stay | 2023 Jun. 2 | 2023 Jun. 2 | 5372 | (116.25736, |
| on June 2) | 23:36 | 23:36 | | 39.90084) |
| 3-1(1st stay | 2023 Jun. 3 | 2023 Jun. 3 | 5440 | (116.33541, |
| on June 3) | 0:00 | 23:50 | | 38.95362) |

. . .

In the present invention, step S2 will perform residence location identification, specifically including:
identifying the user's place of residence, defining the user's stay at night from 21:00 of the same day to 8:00 of the next day, and taking user U₅₇₅ as the object, summarizing the total accumulated monthly residence time of users in different residence locations, and taking the residence point with the largest residence time and the highest residence frequency at night as the location of the user U₅₇₅, denoting as A_{U}_{₅₇₅}={X_{U}_{₅₇₅}′ Y_{U}_{₅₇₅}}, and calculating that the cellular base station grid area to which the user's residence belongs is AREA=“3089”, and estimating the user's residence in the grid by the multi-base station weighting algorithm for monthly data as A_{U}_{₅₇₅}= {X_{U}_{₅₇₅}, Y_{U}_{₅₇₅}}=(114.209542,30.465893).

In the present invention, the distance relationship between of residences of different users is determine, one-to-one user combination of a certain user and other users is constructed and all user combinations are obtained by traversing all users, if the straight-line distance between the residences of the user combination is less than a distance threshold, it is determined that there may be a user pair with a family relationship, specifically including the following.

For all other users P={P₁, P₂, . . . , P₃₈₇₉₄₈₀} excepting the user U₅₇₅, the above steps

$$D = \{ {D}_{{A}_{{U}_{575}} {A}_{{P}_{1}}} , {D}_{{A}_{{U}_{575}} {A}_{{P}_{2}}} , … , {D}_{{A}_{{U}_{575}} {A}_{{P}_{s}}} \}$$

between all other user dataset Q and the residence of user U₅₇₅ is calculated separately. The users in the D dataset that are less than or equal to 0.3 km (the average coverage accuracy of base stations in a downtown area is 300×300 m range) are selected, and through the calculation, there are 5 users satisfying the conditions, A_{P}_{₁₀₃₇₈₁}=(114.230526,30.465027), A_{P}_{₄₂₅₇}=(114.228974,30.453217), A_{P}_{₁₆₃}=(114.235340,30.465317), A_{P}_{₉₁₈₈₀₉}=(114.209467,30.465774), A_{P}_{₅₃₃₆₂₈}=(114.209533,30.465368), the straight-line distance (km) between P₁₀₃₇₈₁, P₄₂₅₇, P₄₂₅₇, P₄₂₅₇, P₄₂₅₇ and the user U₅₇₅ is calculated to be D={0.3,0.1,0.2, 0.2}. The above users who satisfying the threshold condition of distance from residence are screened out to form the user dataset Q. It is believed that that these six users may have a family relationship, and the collection of user pairs U₅₇₅Q={U₅₇₅Q₁₀₃₇₈₁, U₅₇₅ Q₄₂₅₇, U₅₇₅ Q₁₆₃, U₅₇₅ Q₉₁₈₈₀₉, U₅₇₅ Q₅₃₃₆₂₈} is constructed.

In the present invention, step S3, based on the collection of user pairs that may have a family relationship in step S2 above, determines whether or not there is a spatial-temporal accompanying behavior between the user pairs by means of a spatial-temporal accompanying algorithm. This specifically includes the following.

Comparing with non-family members, users with family relationships tend to have common leisure travel activities on double cease day and holidays, so the “spatial-temporal residence frequency of users going to parks, shopping malls, etc. on double cease day” is proposed. For the collection of user pairs U₅₇₅Q with common residence in step S3, the residence records at the same location on the double cease day and holidays (including June 3, June 4, June 10, June 11, June 17, June 18, June 24, and June 25) in June 2023 is extracted, further the residence start-end time data is obtained, and a residence time difference dataset

$$ST = \{ {ST}_{{U}_{57 {5}_{stime}}} {ST}_{{Q}_{{n}_{stime}}} , {ST}_{{U}_{57 {5}_{etime}}} {ST}_{{Q}_{{n}_{etime}}} \}$$

is computed and formed so that the absolute values of

$${ST}_{{U}_{57 {5}_{stime}}} - {ST}_{{Q}_{{n}_{stime}}} and {ST}_{{U}_{57 {5}_{stime}}} - {ST}_{{Q}_{{n}_{stime}}} \leq 30 ( minutes ) ,$$

and finally the user's spatial-temporal accompanying residence frequency dataset SF_{U}_{₅₇₅}_{Q}_{ₙ}^{T} is formed, which is the spatial-temporal accompanying residence frequency of the user U₅₇₅Q on the double cease day and holidays in June 2023.

Proposing an indicator of “the number of spatial-temporal accompanying residence”, denoting as SD_{U}_{₅₇₅}_{Q}_{ₙ}^{T}, i.e., the number of days of spatial-temporal accompanying residence in which the user pair (U_ID_{U}_{₅₇₅}, U_ID_{Q}_{ₙ}) has significant spatial-temporal accompanying behavior on the weekend of June 2023. For the set U₅₇₅Q of five user pairs that may have a family relationship with the user U₅₇₅ in step S3, their spatial-temporal accompanying residence frequency and the number of spatial-temporal accompanying residence days are described as shown in Table 3.

Table 3 shows a description table of spatial-temporal accompanying residence frequency and the number of spatial-temporal accompanying residence days of user pairs in the dataset U₅₇₅Q.

| | | Spatial-temporal | Number of |
|---|---|---|---|
| | | accompanying | spatial-temporal |
| | | residence | accompanying |
| | | frequency | residence days |
| Uid A | Uid B | (SF_{U575Qn}^{T}) | (SD_{U575Qn}^{T}) |
| 575 | 103781 | 0 | 0 |
| 575 | 4257 | 1 | 0 |
| 575 | 163 | 1 | 1 |
| 575 | 918809 | 8 | 4 |
| 575 | 533628 | 7 | 3 |

In spatial-temporal accompanying relationship discrimination, based on spatial-temporal accompanying behavior over the weekend of June 2023, for each user pair of U₅₇₅Q, a dataset P={SF_{U}_{₅₇₅}_{Q}_{ₙ}^{T},SD_{U}_{₅₇₅}_{Q}_{ₙ}^{T}} of the spatial-temporal accompanying residence frequency and the number of spatial-temporal accompanying residence days is constructed and family relationship discrimination is further performed. Based on the kneed algorithm, the point with the maximum curvature on the curve is selected as the inflection point: firstly, generating the fitting curve of spatial-temporal accompanying contact pairs and the number of residence day, calculating the curvature of each point, and selecting the point with the maximum curvature as the threshold e of the number of spatial-temporal accompanying residence days, then, on the basis of satisfying the the number of the spatial-temporal accompanying residence days, generating the fitting curve of the spatial-temporal accompanying contact pairs and the residence frequency, and likewise selecting the point with the maximum curvature as a threshold value f of the spatial-temporal accompanying residence frequency, where the values of e and f are set to be 2 and 5, respectively, then considering that “there may be a family relationship” between the two users, otherwise it is a non-family relationship. Accordingly, the user feature set 0={SF_{U}_{₅₇₅}_{F}_{₉₁₈₈₀₉}^{T},SF_{U}_{₅₇₅}_{F}_{₅₃₃₆₂₈}^{T},SD_{U}_{₅₇₅}_{F}_{₉₁₈₈₀₉}^{T},SD_{U}_{₅₇₅}_{F}_{₅₃₃₆₂₈}^{T}} that may have family relationships is extracted.

In the present invention, by step S4, the family group clusters H₅₇₅={U₅₇₅, Q₉₁₈₈₀₉, Q₅₃₃₆₂₈} associated with the H₅₇₅ related to H_575 is obtained.

In the present invention, it is also based on the value of the difference between the age of the oldest user and the age of the youngest user in the cluster, and the number of times a user in the cluster temporarily visited the space of the educational facility during a fixed period of time on a weekday. Specifically includes the following.

Identification of family generation types based on gender and age. Based on the possible existence of family group clusters identified in step 6, the gender and age attributes of the users in the clusters are obtained, the absolute value of the age difference of the users in the clusters is calculated, denoted

$$asA = \{ {H}_{57 {5}_{{u}_{575} {f}_{918809}}} , {H}_{57 {5}_{{u}_{575} {f}_{533628}}} , {H}_{57 {5}_{{u}_{918809} {f}_{533628}}} \} ,$$

and the maximum age difference value is selected to identify the generational differences in family relationships. For this user cluster, considering the legal age of marriage in China, the age difference values of the one-generation and the two-generation is taken as 25 and 50 respectively. It is defined as follows: when A<25, the relation between generations in family may be a “one-generation family”, the cluster is labeled as “1”, considering the situation of staff dormitory and group dormitory, the cluster of “number of people of the same gender ≥2” is screened out and labeled as “0”; when 25≤A<50, the relation between generations in family is the “two-generation family”, and the cluster is labeled as “2”; when 50≤A, the relation between generations in family is the “three-generation family”, the cluster is labeled as “3”. According to this method, the age difference of users in cluster A is A={30,0,25}, that is, the age difference between the oldest user and the youngest user is 30 years old, and he relation between generations in family is likely to be a “two-generation family”, and the cluster is labeled as “2”.

Based on the number of spatial residencies in educational facilities family generation relationship refinement identification. Since most of the children of families in China do not have cell phones in kindergarten and elementary school, big data cannot identifying their user attribute information, so on the basis of the identification of family generation types in step 701, the number of times users in cluster H₅₇₅ stayed in in the space of educational facilities such as elementary school and kindergartens (derived from the June 2023 Gaode map AOI data) from Monday to Friday in June 2023 is counted as E_SD_{U}_{ᵢ}^{T}, and the relation between generations in family in Step 701 are further subdivided. The statistics show that the number of days that three users “U₅₇₅, Q₉₁₈₈₀₉, Q₅₃₃₆₂₈” in cluster H₅₇₅ stayed in educational facilities is E_SD_{U}_{ᵢ}^{T}={0,3,10}, and the age of the youngest user in the family, Q₅₃₃₆₂₈, ≥25 years old, indicating that there are children in the family, and thus the two-generation family is changed to the three-generation family, and the cluster is re-labeled as “3”. The above approach can be extended to all users and refining the identification of family generation types.

The present invention also provides a family identification system based on social networks and spatial-temporal accompanying behaviors, as shown in FIG. 3, comprising:
a data acquisition module, configured to construct a collection of basic attribute data and spatial-temporal residence behavior data corresponding to all users in a time period T in a study area based on cell phone positioning big data;
a user pair set establishment module, configured to obtain residences of all users based on the collection of the basic attribute data and the spatial-temporal residence behavior data, and to build a collection of user pairs for the user pairs whose residences are located at a distance that satisfy a distance threshold;
a spatial-temporal accompanying model building module, configured to establish a spatial-temporal accompanying model, screen user pairs that have occurred spatial-temporal accompanying behavior during double cease day and holidays in the time period T, determine that the user pairs with a number of spatial-temporal accompanying residence days reaching a threshold of the number of spatial-temporal accompanying residence days and a spatial-temporal accompanying residence frequency reaching a threshold of the spatial-temporal accompanying residence frequency have a family relationship, and iteratively obtain all possible user pairs with the family relationship;
a social network modeling module, configured to construct a social network model by clustering the all possible user pairs with the family relationships to form different groups of connected subgraph clusters, and identify clusters with a number of users within the connected subgraph clusters that satisfy a number threshold as a family group cluster;
a relation between generations identification module, configured to classify relation between generations in family according to a value of difference between ages of an oldest user and a youngest user in the family group cluster, and a number of times that users in the family group cluster temporarily visited a space of an educational facility during a fixed period of time on a weekday.

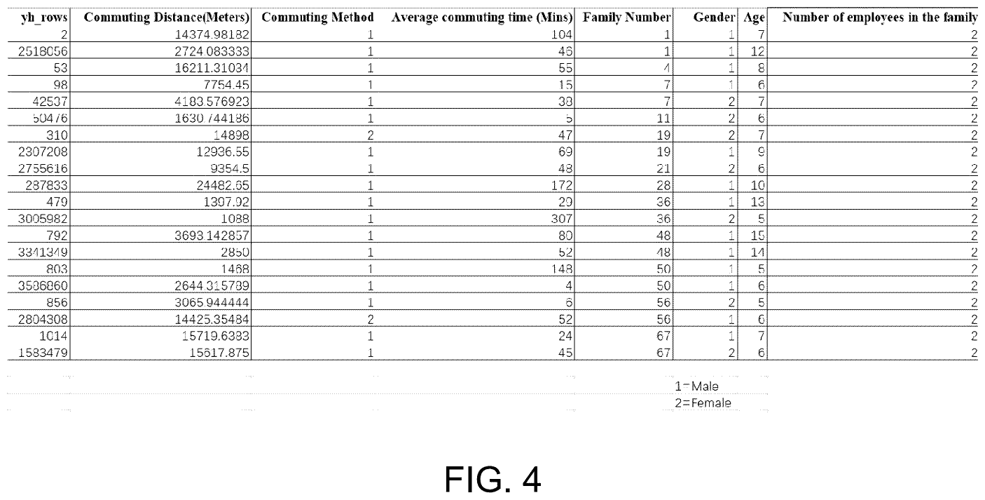

Example 1: FIG. 4 indicates with identified household samples, the basic attributes of the household members (age, gender, number of household members, etc.) can be obtained, and further obtain the household members' place of employment and their commuting attributes (commuting distance, commuting time, commuting mode, etc.) through the user's monthly residency data. As shown in FIG. 4, yh_rows represents the user's unique identifier (binding ID card), commuting distance represents the user's commuting distance (meters), commuting method represents the user's commuting mode (1 is car or bus, 2 is subway), average commuting time represents the user's average commuting time on the weekdays of each month, and average commuting time represents the user's average commuting time on the weekdays of each month. average commuting time (in minutes), family number represents the family number to know which users are located in the same family, gender is the gender attribute (1 is male, 2 is female), age represents the age attribute of each family member, and the last column represents the number of employed people in the family. With the above data, the present invention is able to determine the interaction relationship and decision-making pattern of families on multi-member commuting, as well as the possible impact on the spatial structure of the city.

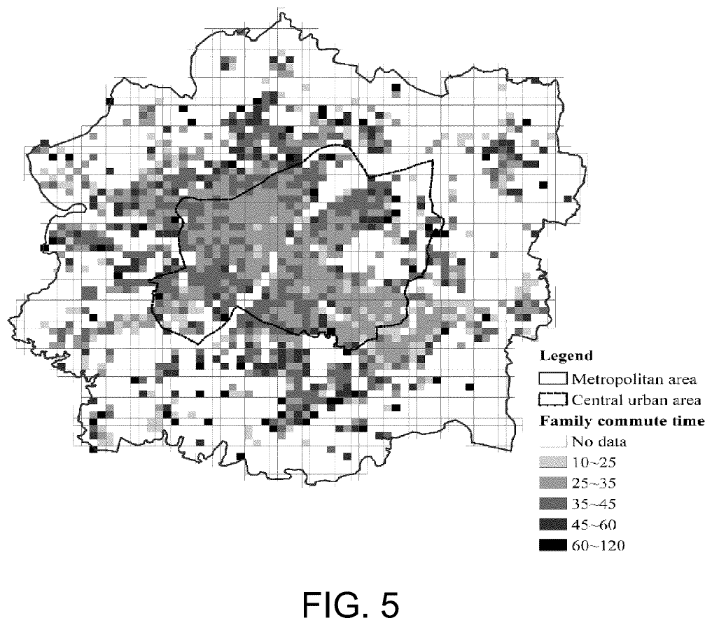

Example 2: FIG. 5 is generated based on the above family identification method to analyze the scenario of uneven spatial distribution of urban family commuting time. By filtering dual-income families, their commuting time (in minutes) is further obtained and counted according to family units, and finally summarized into a 1 km*1 km urban grid. The example reflects the uneven spatial distribution of family commuting time in the city, with the commuting time of suburban families far exceeding that of the central city.

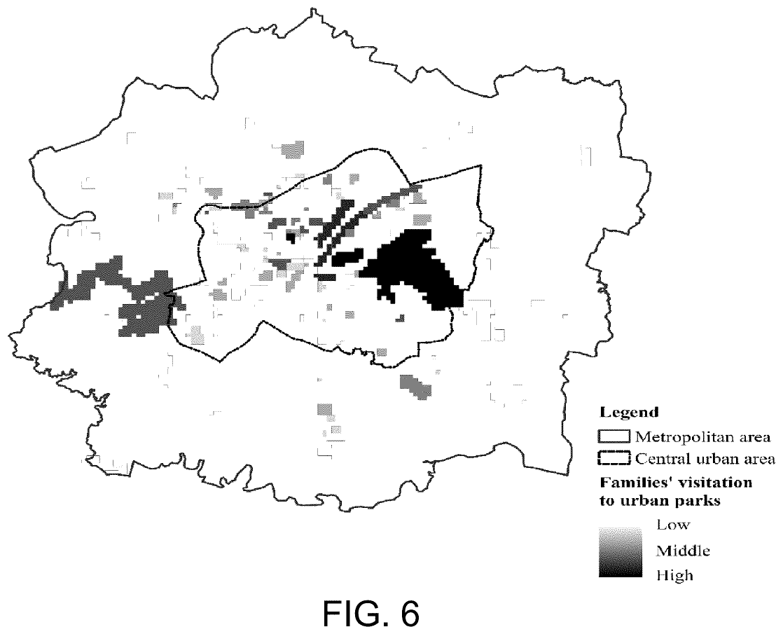

Example 3: FIG. 6 demonstrates the identification of household visits to city parks through big data. Data based on household activities, including frequency of visits, distance traveled, travel time, length of stay, etc., are used so as to reflect the overall situation of household use of urban parks. The method is also applicable to household visits to different urban facilities such as shopping malls and culture to highlight household usage performance, which can provide a basis for urban planning and regulation.

The present invention also provides family identification device based on social network and spatial-temporal accompanying behaviors, comprising: a processor, and a memory, said memory storing a computer program, said computer program, when executed by said processor, realizing the steps of the above-describe family identification method based on social network and spatial-temporal accompanying behavior.

The present invention also provides a non-transitory computer storage medium, said storage medium storing a computer program. Due to the necessity to store process data and results data during data processing, non-transitory hardware storage medium capacity should not be less than 512 GB disc drive; the present invention implements the disc drive model SAMSUNG MZVLB512HBJQ-000L2. Also, A high-performance computing systems with two AMD EPYC™ 7003 series processors (including versions like 7763, 7T83, 7J13, 7K83, and 7W83) with a combined 128 cores and 256 threads was used in present invention. The AMD Zen 3 architecture serves as the foundation for these processors, which are produced utilizing a 7 nm technology and offer substantial computing power and parallel processing capabilities. With 1 TB of DDR4 memory (3200 MT/s), the system supports an 8-channel memory architecture and reach a maximum memory bandwidth of 409.6 GB/s. This setup offers strong hardware support for research by facilitating the effective management of data analysis, machine learning, virtualization by facilitating the effective management of data analysis, machine learning, virtualization, realizing the steps of the above-described family identification method based on social networks and spatial-temporal accompanying behaviors.

The present invention proposes a family identification algorithm based on social network and spatial-temporal accompanying behaviors, which realizes efficient computation and closed-loop feedback through a specially structured real-time server cluster, which consists of core components including distributed data acquisition module, parallel computation engine, graph database cluster, intergenerational relationship decision-making unit, and closed-loop interface for user feedback, in which the distributed data acquisition module is deployed at the edge node. The distributed data collection module is deployed at the edge nodes, integrates multi-source heterogeneous data interfaces, collects basic user attributes (e.g., uid, age, gender) and spatial-temporal residency behavioral data (residency location, timestamps) in the cell phone positioning big data in real time, and guarantees data privacy transmission with the help of hardware-level encryption chips; the parallel computing engine is based on FPGA-accelerated real-time processing units, and applies spatial-temporal window slicing technology to dynamically divide the data flow within a time period T The parallel computing engine is based on FPGA-accelerated real-time processing unit, using spatial-temporal window slicing technology to dynamically divide the data flow within a time period of T, and can execute user residence identification (using weighted base station positioning algorithm) and spatial-temporal accompanying behavior detection (residency time difference threshold determination) in parallel to effectively reduce the computational latency. The intergenerational relationship decision-making unit integrates a dedicated ASIC chip, combining a rule engine and a dynamic threshold calibration module to automatically classify intergenerational relationships based on the age difference in family clusters and the frequency of visits to educational facilities (with the help of GPU-accelerated spatial-temporal pattern matching algorithms), and generates an interpretable report; the closed-loop interface for user feedback connects to end-user devices via a low-latency API gateway, which can provide the identification results (e.g., the number of users) to end-users. The user feedback closed-loop interface is connected to end-user devices via a low-latency API gateway, which pushes recognition results (e.g., family group clusters and generational labels) to the user's mobile terminal, and receives corrective feedback from the user (e.g., confirmation or adjustment of the family relationship), which is then transmitted back to the server cluster in real time via the edge-cloud collaborative architecture, which triggers the incremental learning model to update the temporal and spatial concomitant thresholds and the clustering parameters of the social network to form a self-optimizing closed-loop. The server cluster adopts heterogeneous computing architecture (CPU+FPGA+GPU+ASIC), combined with customized data pipeline and hardware acceleration module, to ensure the real-time and accuracy of algorithms under ultra-large-scale datasets, and dynamically enhance the robustness of the model through the closed-loop feedback mechanism.

Obviously, those skilled in the art may make various modifications and variations to the present invention without departing from the spirit and scope of the present invention. Thus, to the extent that such modifications and variations of the present invention fall within the scope of the claims of the present invention and their technical equivalents, the present invention is intended to encompass such modifications and variations.

What is claimed is:

1. A family identification method based on social networks and spatial-temporal accompanying behaviors, characterized by comprising following steps:
based on cell phone positioning big data, constructing a collection of basic attribute data and spatial-temporal residence behavior data corresponding to all users in a time period T in a study area;
based on the collection of the basic attribute data and the spatial-temporal residence behavior data, obtaining residences of all users, and building a collection of user pairs for the user pairs whose residences are located at a distance that satisfy a distance threshold;
establishing a spatial-temporal accompanying model, screening user pairs that have occurred spatial-temporal accompanying behavior during double cease day and holidays in the time period T, determining that the user pairs with a number of spatial-temporal accompanying residence days reaching a threshold of the number of spatial-temporal accompanying residence days and a spatial-temporal accompanying residence frequency reaching a threshold of the spatial-temporal accompanying residence frequency have a family relationship, and iteratively obtaining all possible user pairs with the family relationship;
constructing a social network model by clustering the all possible user pairs with the family relationship to form different groups of connected subgraph clusters, and identifying clusters with a number of users within the connected subgraph clusters that satisfy a number threshold as a family group cluster;
classifying relation between generations in family according to a value of difference between ages of an oldest user and a youngest user in the family group cluster, and a number of times that users in the family group cluster temporarily visited a space of an educational facility during a fixed period of time on a weekday.

2. The family identification method based on social networks and spatial-temporal accompanying behaviors according to claim 1, further comprising:
defining spatial-temporal residence behavior data formed when a user who stays at a same location for a period of time exceeding a stay time threshold, wherein the spatial-temporal residence behavior data includes a residence location, residence start time, residence end time and residence duration, and the basic attribute data includes a user's unique identifier code, age and gender.

3. The family identification method based on social networks and spatial-temporal accompanying behaviors according to claim 1, further comprising:
according to the spatial-temporal residence behavior data, taking a residence location with a longest residence duration and a highest frequency at night as a residence of the user, constructing a one-to-one user combination between one user and other users, and traversing all users to obtain all user combinations, and if a straight-line distance of residences of the user combinations is less than a distance threshold, determining the user combinations as a user pair.

4. The family identification method based on social networks and spatial-temporal accompanying behaviors according to claim 1, wherein the method for establishing the spatial-temporal accompanying model comprises:
based on the spatial-temporal residence behavior data of the user, obtaining residence start time and residence end time of two users in a user pair at a same place of residence, wherein if an absolute value of difference between the two user's residence start time and an absolute value of difference between the two user's residence end time is less than a threshold of a time difference of the two users, it is regarded as one spatial-temporal accompanying behavior, the spatial-temporal accompanying residence frequency of all user pairs in the double cease day and holiday periods in one period of time is calculated, and the number of spatial-temporal accompanying residence days is obtained and counted according date attribute in the residence start time or the residence end time corresponding to the spatial-temporal accompanying behavior.

5. The family identification method based on social networks and spatial-temporal accompanying behaviors according to claim 1, wherein the method for constructing the social network model comprises:
clustering the user pairs, recursively traversing all unvisited users that have spatial-temporal accompanying connections with a particular user, building a social network model undirected graph including all users, extracting a plurality of disconnected connected subgraph clusters through the social network model undirected graph, and selecting, in each of the connected subgraph clusters, a connected subgraph cluster with a number of users not exceeding 6 as a home grouping cluster.

6. The family identification method based on social networks and spatial-temporal accompanying behaviors according to claim 1, further comprising:
assume that the value of the difference between the ages of the oldest user and the youngest user in the family group cluster is A, when A<A1, the relation between generations in family is a one-generation family, and the family group cluster is screened out if a number of people of a same gender is greater than or equal to 2;
when A1≤A<A2, the relation between generations in family is a two-generation family;
when A>A2, the relation between generations in family is a three-generation family.

7. The family identification method based on social networks and spatial-temporal accompanying behaviors according to claim 1, further comprising:
obtaining the number of times that all users in the family group cluster temporarily visited the space of the educational facility during the fixed period of time on the weekday, and when the number of times for temporarily visiting the space of the educational facility reaches a space visit count threshold and the age of the youngest user in the family group cluster is greater than or equal to 20 years old, elevating the relation between generations in family by one level.

8. A family identification system based on social networks and spatial-temporal accompanying behaviors, characterized by comprising:
a data acquisition module, configured to construct a collection of basic attribute data and spatial-temporal residence behavior data corresponding to all users in a time period T in a study area based on cell phone positioning big data;
a user pair set establishment module, configured to obtain residences of all users based on the collection of the basic attribute data and the spatial-temporal residence behavior data, and to build a collection of user pairs for the user pairs whose residences are located at a distance that satisfy a distance threshold;
a spatial-temporal accompanying model building module, configured to establish a spatial-temporal accompanying model, screen user pairs that have occurred spatial-temporal accompanying behavior during double cease day and holidays in the time period T, determine that the user pairs with a number of spatial-temporal accompanying residence days reaching a threshold of the number of spatial-temporal accompanying residence days and a spatial-temporal accompanying residence frequency reaching a threshold of the spatial-temporal accompanying residence frequency have a family relationship, and iteratively obtain all possible user pairs with the family relationship;
a social network modeling module, configured to construct a social network model by clustering the all possible user pairs with the family relationship to form different groups of connected subgraph clusters, and identify clusters with a number of users within the connected subgraph clusters that satisfy a number threshold as a family group cluster;
a relation between generations identification module, configured to classify relation between generations in family according to a value of difference between ages of an oldest user and a youngest user in the family group cluster, and a number of times that users in the family group cluster temporarily visited a space of an educational facility during a fixed period of time on a weekday.

9. A family identification device based on social network and spatial-temporal accompanying behaviors, characterized by comprising: a processor and a memory, the memory having a computer program stored thereon, the computer program, when executed by the processor, realizing the steps of the family identification method based on social network and spatial-temporal accompanying behaviors according to claim 1.

10. A non-transitory computer storage medium, storing a computer program, wherein the computer program, when executed by a processor, realizes the steps of the family identification method based on social network and spatial-temporal accompanying behaviors according to claim 1.
